(19) United States
(12) Patent Application Publication
(10) Pub. No.: US 2009/0210782 A1
(43) Pub. Date: Aug. 20, 2009

(54) METHOD AND DEVICE FOR COMPILING AND EVALUATING A PLURALITY OF EXPRESSIONS TO BE EVALUATED IN A STRUCTURED DOCUMENT

(75) Inventor: Franck Denoual, Rennes-Atalante (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/340,100

(22) Filed: Dec. 19, 2008

(30) Foreign Application Priority Data
Dec. 21, 2007 (FR) FR07/09007

(51) Int. Cl. G06F 17/00

(52) U.S. Cl. 715/234

(57) ABSTRACT

The present invention relates to a method and device for compiling and evaluating a plurality of expressions to be evaluated in a structured document.

The compilation method comprises, for each expression of the plurality of expressions to be evaluated, a step (E4) for determining the relative or absolute type of said expression, a relative expression being an expression, the evaluation of which depends on the evaluation of at least one other expression of the plurality of expressions. If said expression is a relative expression, the determination step is followed by a step (E7) for obtaining a context expression associated with said relative expression from the expressions of the plurality of expressions processed previously. Finally, the method comprises a step (E8) for constructing a compiled representation for said expression to be evaluated, such that a compiled relative expression representation comprises a link to the compiled representation of the associated context expression.

The present invention relates to a method and a device for compiling a plurality of expressions to be evaluated in a structured document and a method and device for evaluating a plurality of expressions in a structured document.

The invention relates to the technical field of markup languages such as XML (acronym standing for “Extensible Markup Language”), and in particular to the field of evaluating or filtering XML documents by using XPath expressions (XPath being an abbreviation of “XML Path Language”).

The XML language is a syntax that can be used to define computer languages, suitable for different uses but which can be processed by the same tools. XML is in the process of becoming a standard for structured representation and the exchange of data over the Internet.

A document in XML format consists of a set of information items, or nodes according to the XML specification (see XML Information Set, at http://www.w3.org/TR/xml-infoset/). Each node can be of different types: root for the start of a document, element, attribute, text, comment, processing instruction or namespace. An XML node can be broken down, in particular for on-the-fly processing, into a series of events, such as, for example, element start and element end.

For example, each element begins with an opening marker comprising the name of the element (for example: <marker>) and ends with a closing marker, also comprising the name of the element (for example </marker>). Each element can include other elements, called “child elements”, or textual data. Thus, the XML syntax makes it possible to define nested elements having a hierarchical structure represented by a descendant relationship. Also, an element can be specified by attributes, each attribute being defined by a name and having a value.

Moreover, the XML syntax makes it possible to define comments (for example <!—Comment—>) and processing instructions, which can specify to a computer application the processes to be applied to the XML document.

Furthermore, a number of different languages based on XML can contain elements with the same name. In order to manage this particular situation, the XML syntax makes it possible to define namespaces. Thus, two elements are identical only if they have the same name and are located in the same namespace.

XPath is a specification of the W3C (World Wide Web Consortium, an organization which produces standards for the Internet), which defines a syntax for addressing parts of an XML document.

The XPath syntax, defined in the document that can be found at http:/www.w3.org/TR/xpath (XML Path Language (Xpath) version 1.0, W3C recommendation 16 Nov. 1999, published by W3C), defines four data types, which are string, boolean, number and node set, and expressions for manipulating these data items. The XPath 1.0 specification, as well as the XPath 2.0 specification, defines seven node types. Hereinafter, for simplicity, we will use the general term ‘XPath’, referring to both the XPath 1.0 and the XPath 2.0 syntaxes. An XPath node can be used to represent the different types of XML events reviewed briefly above. The XPath syntax defines a grammar defining the rules for constructing XPath expressions.

The XPath expressions can be grouped together into two categories, navigation expressions and computation expressions.

The so-called navigation expressions are expressions which return an ordered list of XPath nodes, known as solution nodes.

In particular, a navigation expression comprises a location path (known by the name of LocationPath in the XPath syntax). A location path can be absolute or relative. An absolute location path can be evaluated from the root of a document, and begins with a ‘/’ or ‘//’ symbol depending on the XPath syntax. A relative location path must be evaluated from a current node being considered, referred to as a context node.

Any location path type expression consists of one or more path steps (known simply as Steps in the XPath terminology). A path step can be mapped to a depth level in an XML document. For example, the expression ‘/cd/title’ contains two path steps which are ‘cd’, which will be looked for in an XML document to depth 1, and ‘title’, which will be looked for in the XML document to depth 2. A path step is evaluated in relation to the result of the evaluation of the parent path step, that is, the one that precedes it in the location path type expression.

Any path step (Step) type expression consists of three entities:
AxisSpecifier, optional (child by default), describes the descendant or ascendant relationship between the context node and the solution nodes of the Step. The AxisSpecifier is a keyword from 13 keywords predefined by the XPath syntax, followed by “::”. For example: /a/child::b or /a/attribute::b respectively mean that you should look for a child node “b” of a node “a” and a child attribute node “b” of a node “a”, the node “a” being located directly under the root of the document;
NodeTest, mandatory, defines the type constraint (for example node( ), text( ), comment( ) or processing-instruction( )) or name constraint (prefix+name) that nodes must respect to be considered as solutions of the Step. For example, /child::b which looks for children named “b”, of the document root as a name constraint, whereas /descendant::comment( ) can be used to search for all the comment type nodes;
Predicate, optional, can be used to impose additional conditions for the search for solution nodes. A “predicate” expression is indicated by square brackets: “[ . . . ]” and follows the same construction rules as any XPath expression. For example: /a/b[2] can be used to select all the second children “b” of each element “a”; /a/b[@id=“3”] can be used to select the children “b” of “a” having an “id” attribute that has a value equal to 3.

The so-called computation expressions can also be of several types:
expressions returning a boolean: OrExpr, AndExpr, RelativeExpr,
EqualityExpr;
expression returning a number: AdditiveExpr, MultiplicativeExpr;
expressions returning any type: FilterExpr and in particular FunctionCalls.

It is also possible to introduce the concept of relative or absolute expression for a computation expression. Thus, any computation expression which explicitly or implicitly contains as a parameter, argument or operand a relative location path is considered as a relative expression.

There are several languages defined by the W3C consortium which use the XPath syntax to define processing requests on XML documents. For example, XSLT (acronym for “XML Style Sheet Transformation”, defined at http://www.w3.org/TR/xslt) can be used to define requests on XML documents with a view to their transformation, XPointer (http://www.w3.org/TR/WD-xptr) can be used to define requests to rapidly access subparts of XML documents and XQuery (http://www.w3.org/TR/xguery) can be used to define requests to perform processes on parts of XML documents.

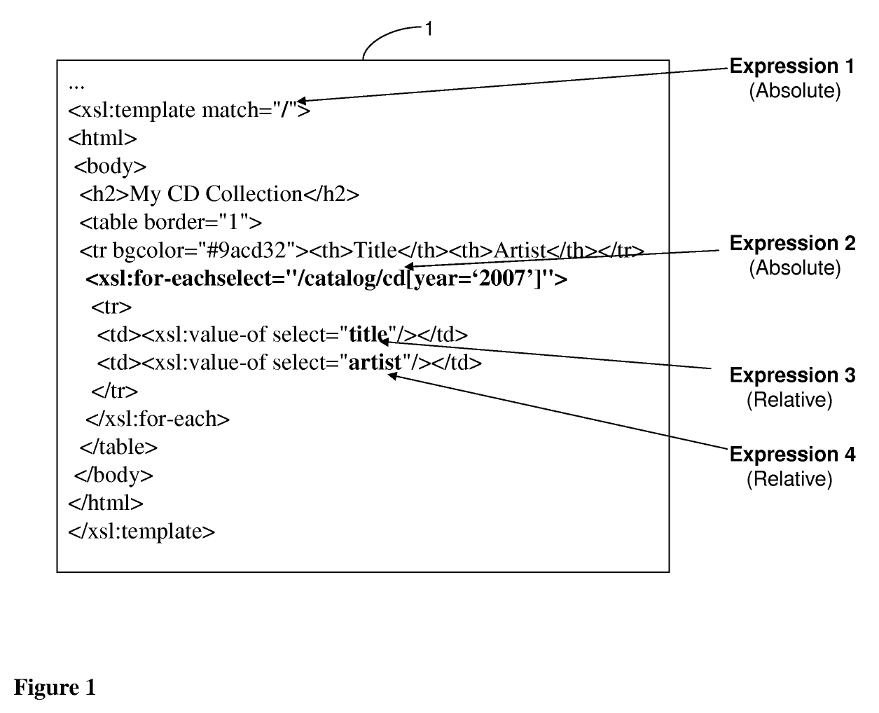

FIG. 1 illustrates an example of document 1 in XSLT format, comprising instructions for creating a document entitled ‘My CD Collection’, containing the titles (‘title’) and artist names (‘artist’) of CDs from the year 2007, organized in a table, these CDs being from an XML document containing a ‘catalog’ element having ‘cd’ type child elements.

As shown in FIG. 1, the document 1 contains four XPath expressions:
Expression 1:
Expression 2: /catalog/cd[year=‘2007’]
Expression 3: “title”
Expression 4: “artist”

The first two (Expression 1, Expression 2) are absolute expressions, and the next two (Expression 3, Expression 4) are relative expressions.
The example of FIG. 1 illustrates the fact that a language like XSLT generates a plurality of XPath expressions, to be evaluated in one and the same XML document.

It is therefore necessary to be able to evaluate, simultaneously and effectively, a plurality of XPath expressions in one or more XML documents.

The entity responsible for the XPath evaluation is called ‘XPath processor’. An XPath processor takes as input, on the one hand, one or more XPath expressions, and on the other hand, a reference to XML data, read from a file or received via a network transmission, on which the XPath expression or expressions need to be evaluated.

One possible implementation of an XPath processor would consist in constructing an intermediate representation of the XML data in the form of a DOM tree (DOM being an acronym for ‘Document Object Model’, defined according to the W3C recommendation http://www.w3.org/TR/2004/NOTE-DOM-Level-3-XPath-20040226/xpath.html), and in scanning this tree as many times as are needed to extract the XML nodes resulting from the XPath expression or expressions to be evaluated. Such an approach raises a number of problems.

On the one hand, it is memory-intensive, in particular for processing large XML documents. This is a particular drawback when the XPath processor is located in an embedded device, such as, for example, a camera or a photocopier, which normally has limited memory resources.

On the other hand, such an approach entails scanning multiple times through the tree structure stored in memory, which is incompatible with the on-the-fly processing of XML data (also called ‘streaming’). On-the-fly processing is in particular necessary in the case where the XML data originates from the messages exchanged between client and service devices communicating via a communication network. In particular, the Web services use XML language messages, for example SOAP messages, for the transmission of services and WSDL messages for the description of services.

In patent application US20060167869, entitled ‘Multi-path simultaneous XPath evaluation over data streams’, there is proposed a method of evaluating on the fly multiple XPath expressions on XML data, therefore during a single scan of the XML document. In this method, each expression is represented by a multiple-input node graph. For the relative expressions, only the case of multiple relative expressions of the same depth is considered in this patent application. The depth of the path steps of the expressions processed is used to construct the node graph. This method has the drawback of having to manage, in a relatively complex way, the use or non-use of an evaluation context as each XPath expression is evaluated. Furthermore, this method cannot be used to effectively process relative expressions having path steps of any depth level.

The aim of the present invention is to allow for the on-the-fly evaluation of multiple XPath expressions, absolute or relative. Furthermore, the present invention aims to propose a method that is effective in terms of computation cost.

To this end, the present invention proposes a method of compiling a plurality of expressions to be evaluated in a structured document. This method comprises, for each expression of the plurality of expressions to be evaluated, the steps of:

determining the relative or absolute type of said expression, a relative expression being an expression, the evaluation of which depends on the evaluation of at least one other expression of the plurality of expressions,

if said expression is a relative expression, obtaining a context expression associated with said relative expression from the expressions of the plurality of expressions processed previously,

constructing a compiled representation for said expression to be evaluated, such that a compiled relative expression representation comprises a link to the compiled representation of the associated context expression.

Thus, the invention makes it possible to construct a compiled representation linking the various expressions to be evaluated to each other, and in particular linking the relative expressions to the associated context expressions, so as to be able to condition the evaluation of the relative expressions to that of the associated context expressions. This method has the advantage of proposing such a link at the compiled representation level. This link is constructed once at the time of compilation and can be used numerous times for the evaluation. Thus, the method according to the invention makes it possible to optimize the complexity and the evaluation time of a plurality of expressions in a structured document. The method is particularly applicable in the case of XPath expressions to be evaluated in structured documents in XML format.

According to particular characteristics, the structured document comprises ‘node’ type elements, and the result of the evaluation of a context expression associated with a relative expression comprises at least one node of the structured document.

In one embodiment, the method also comprises a step for associating a unique identifier with the compiled representation of each expression.

Thus, all the expressions to be evaluated can be retrieved easily at the time of the various processes to be applied. In practice, the unique identifier is an index.

According to particular characteristics, an expression to be evaluated comprises at least one subexpression, and the construction step comprises, for an expression to be evaluated, the substeps of:
identifying the subexpressions of said expression to be evaluated and
determining the type of the subexpression identified from the so-called navigation and computation types.

Thus, it is then possible to process differently, on compilation, the navigation path type subexpressions and the computation type subexpressions, which makes it possible to further enhance the overall processing efficiency.

According to a particular embodiment, in which a navigation subexpression comprises at least one location path step, the construction step comprises, for a navigation type subexpression, a step for representing each location path step of said subexpression in the form of a compiled navigation target, a compiled navigation target comprising at least one information item relating to the path step type. The path step type is selected from the ‘root’ and ‘intermediate’ types.

Such a representation is particularly suitable for the XPath steps.

According to a particular characteristic, the construction step also comprises, for a relative expression, a step for adding an information item indicating a descendant link between the first compiled navigation target of its compiled representation and the last compiled navigation target of the compiled representation of the context expression associated with said relative expression.

In practice, the last compiled navigation target of the compiled representation of the context expression is designated as the parent compiled navigation target of the first compiled navigation target of the relative expression.

Thus, in the compiled representation, a relative expression is linked by a descendant link to its context expression, which makes it possible subsequently to evaluate a relative expression conditionally on the evaluation of its context expression.

According to a particular characteristic, the construction step also comprises, for a relative expression, a step for adding an information item indicating the ‘virtual root’ type for the first compiled navigation target of the compiled representation of said relative expression.

This change of type makes it possible to consider the first compiled navigation target corresponding to a relative expression as a ‘root’ compiled navigation target, which will subsequently induce a particular processing operation at the time of evaluation.

According to one embodiment, the compiled navigation targets are organized in a navigation tree, each compiled navigation target being associated with a node of the navigation tree.

According to one embodiment, the method comprises, for a computation type subexpression, a step for inserting a representation of said computation type subexpression in a node of an instruction tree.

The instruction tree and the navigation tree are grouped together in a compiled representation, said compiled representation also comprising said identifier associated with each expression of the plurality of expressions. According to one embodiment, each identifier associated with an expression of the plurality of expressions is stored in a node of the instruction tree.

Thus, the compiled representation of the expressions to be evaluated is complete, and makes it possible to optimize the processing time at the time of evaluation, thanks to the tree-structured representations of the instruction and navigation trees, and to the links between these two structures.

According to one characteristic of the invention, the step for determining relative expressions comprises, for an expression to be evaluated, the steps of:

lexically analysing said expression

semantically parsing said expression.

Furthermore, in one embodiment, the compilation method according to the invention comprises, after the step for constructing a compiled representation of a current expression, a step for stacking the identifier of said current expression in a storage structure for the identifiers of the expressions to be processed.

In this same embodiment, the step for obtaining a context expression comprises a substep for unstacking the identifier of the expression previously stored in the storage structure for the identifiers of the expressions to be processed.

In this embodiment, it is easy to retrieve the unique identifier of the context expression of a current expression, so as to rapidly retrieve a compiled representation of the context expression of the current relative expression.

According to one embodiment, the step for obtaining a context expression comprises the substeps of:
obtaining the last identifier stored in the storage structure for the identifiers of the expressions to be processed, and
extracting the compiled representation of the compiled context expression from the identifier obtained.

Correlatively, the present invention relates to a device for compiling a plurality of expressions to be evaluated in a structured document. This device is characterized in that it comprises, for each expression of the plurality of expressions to be evaluated:

means of determining the relative or absolute type of said expression, a relative expression being an expression, the evaluation of which depends on the evaluation of at least one other expression of the plurality of expressions,

means, able to be applied if said expression is a relative expression, of obtaining a context expression associated with said relative expression from the expressions of the plurality of expressions processed previously,

means of constructing a compiled representation for said expression to be evaluated, such that a compiled relative expression representation comprises a link to the compiled representation of the associated context expression.

The advantages of this device are the same as the advantages of the method of compiling a plurality of expressions to be evaluated in a structured document, so they are not reviewed here.

According to a second aspect, the invention relates to a method of evaluating a plurality of expressions in a structured document, characterized in that it implements the compilation method as briefly described above and includes an evaluation step implementing the compiled representations of the expressions of the plurality of expressions and each link from a relative expression to the associated context expression.

Thus, the evaluation of a plurality of expressions in a structured document is facilitated, in particular when they are relative expressions, the evaluation of which depends on the result of the evaluation of a context expression. Thanks to the links between relative expressions and context expressions previously stored in the compiled representation structure, this dependency is easily taken into account at the time of evaluation.

According to a particular characteristic, the evaluation step comprises a substep, for each ‘root’ type compiled navigation target, for creating a corresponding evaluation target.

According to one embodiment, the evaluation targets are organized in an evaluation tree according to relationship links between corresponding compiled navigation targets.

According to a particular embodiment, each evaluation target comprises a value indicative of an activation status for the evaluation that can take the values ‘activated’ or ‘deactivated’.

In this embodiment, the evaluation step also comprises the substeps of:

creating a list of evaluation targets to be evaluated according to a current depth level in an evaluation tree, and

for each evaluation target in the list, setting the activation status for the evaluation to ‘activated’ according to the activation status for the evaluation of the parent evaluation target of said target.

Thanks to the addition of this activation status characteristic for the evaluation, it is possible to activate or deactivate certain evaluation targets according to the evaluation state of the parent evaluation targets, and therefore implement a conditional evaluation.

According to one embodiment, the evaluation method also comprises a deactivation step for the evaluation of at least one expression of the plurality of expressions, said deactivation step comprising, for each subexpression of said expression to be deactivated, a substep for marking an evaluation status of said subexpression as ‘terminated’.

In this embodiment, in the case where the subexpression of the expression to be deactivated is of location path type, the method comprises a substep for deactivating the activation status for the evaluation of the first evaluation target corresponding to said subexpression.

According to another embodiment, the evaluation method also comprises a reactivation step for the evaluation of at least one expression of the plurality of expressions, said reactivation step comprising, for each subexpression of said expression to be reactivated, a substep for marking an evaluation status of said subexpression as ‘in progress’.

In this embodiment, in the case where the subexpression of the expression to be reactivated is of location path type, the method comprises a substep for setting the activation status for the evaluation of the first evaluation target corresponding to said subexpression to ‘activated’.

Correlatively, the present invention relates to a device for evaluating a plurality of expressions in a structured document, characterized in that it comprises a device for compiling a plurality of expressions to be evaluated in a structured document as briefly described above and evaluation means implementing the compiled representations of the expressions of the plurality of expressions and each link from a relative expression to the associated context expression.

The advantages of this device are the same as the advantages of the method of evaluating a plurality of expressions in a structured document, so they are not reviewed here.

Correlatively, the present invention proposes a compiled representation of a plurality of expressions to be evaluated in a structured document, the representation comprising a compiled relative expression, which comprises a link to a compiled representation of an associated context expression, the relative expression being an expression, the evaluation of which depends on the evaluation of the context expression.

Correlatively, the present invention proposes a compiled representation generated by a method according to claim 1.

The advantages of the representations of the plurality of expressions are the same as the advantages of the second aspect of the present invention, so they are not reviewed here.

Still with the same purpose, the present invention also proposes a computer program which, when it is executed by a computer or a processor in a device for compiling a plurality of expressions to be evaluated in a structured document, causes the device to implement a method of compiling a plurality of expressions to be evaluated in a structured document as briefly described above. Such a computer program can be supported by a physical information medium.

Still with the same purpose, the present invention also proposes a computer program which, when it is executed by a computer or a processor in a device for evaluating a plurality of expressions to be evaluated in a structured document, causes the device to implement a method of evaluating a plurality of expressions in a structured document as briefly described above. Such a computer program can be supported by a physical information medium.

The invention also relates to an information medium, such as an information storage means, that can be read by a computer or a processor, storing instructions of a computer program intended to implement the method of compiling a plurality of expressions in a structured document as briefly described above.

The invention also relates to an information medium, such as an information storage means, that can be read by a computer or a processor, storing instructions of a computer program intended to implement the method of evaluating a plurality of expressions in a structured document as briefly described above.

The invention also relates to an information medium, such as an information storage means, that can be read by a computer or a processor, storing a representation of a plurality of expressions as briefly described above.

The particular characteristics and advantages of these computer programs and information media are similar to those of the corresponding methods, so they are not repeated here.

Other particular features and advantages of the invention will become further apparent from the description below, illustrated by the appended drawings, in which:

FIG. 1, already described, shows an example of a document in XSLT format;

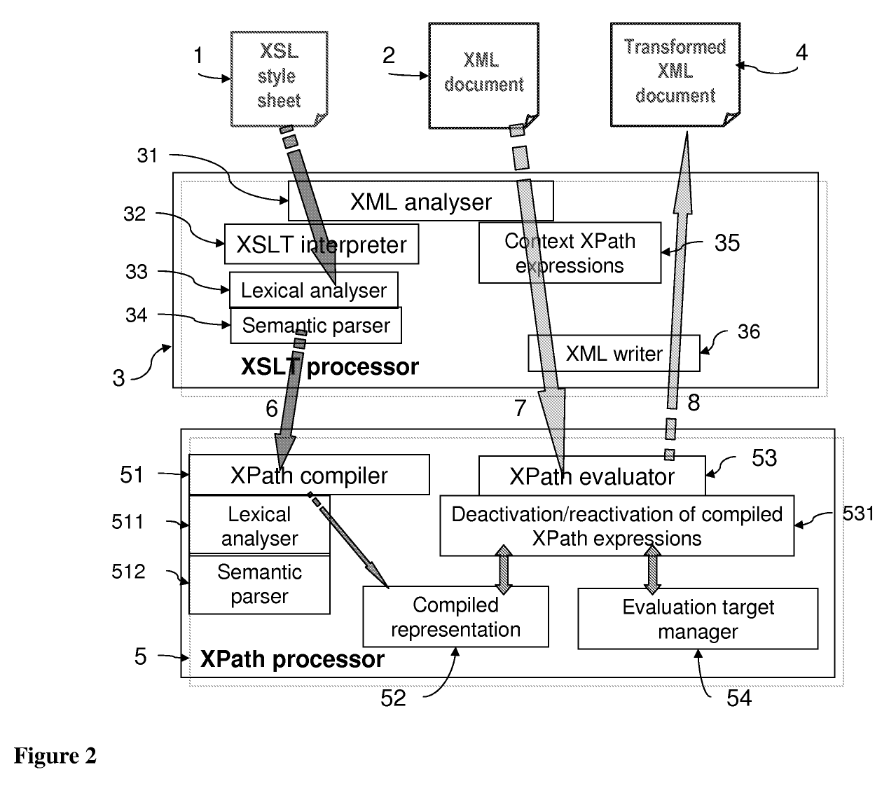

FIG. 2 represents a diagrammatic example of an implementation of the invention in an application dealing with requests in XSLT language;

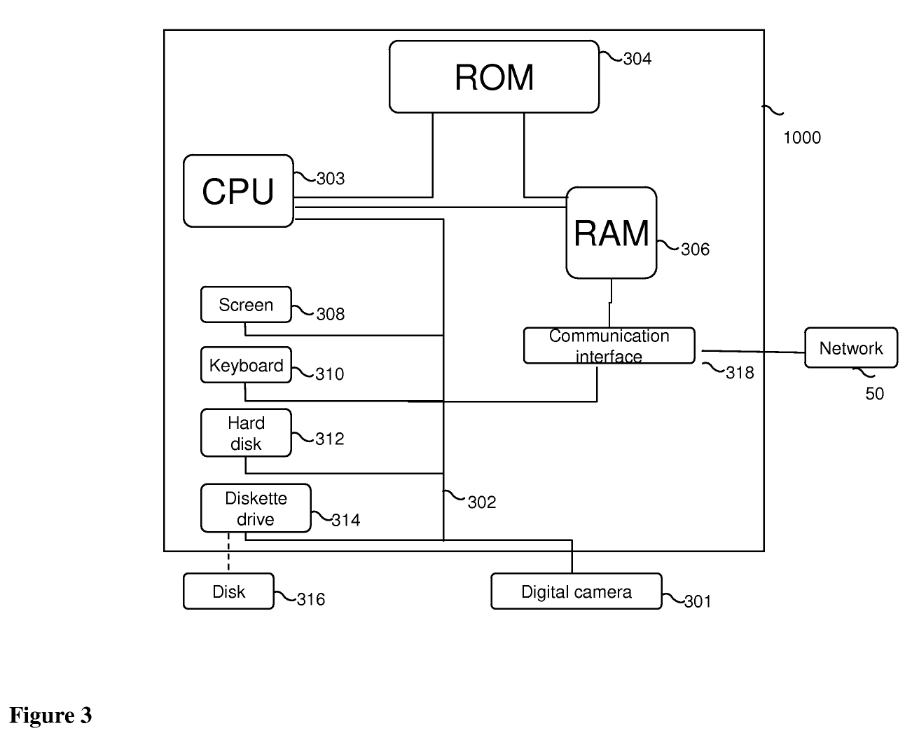

FIG. 3 is a diagram of a processing device 1000 suitable for implementing the present invention;

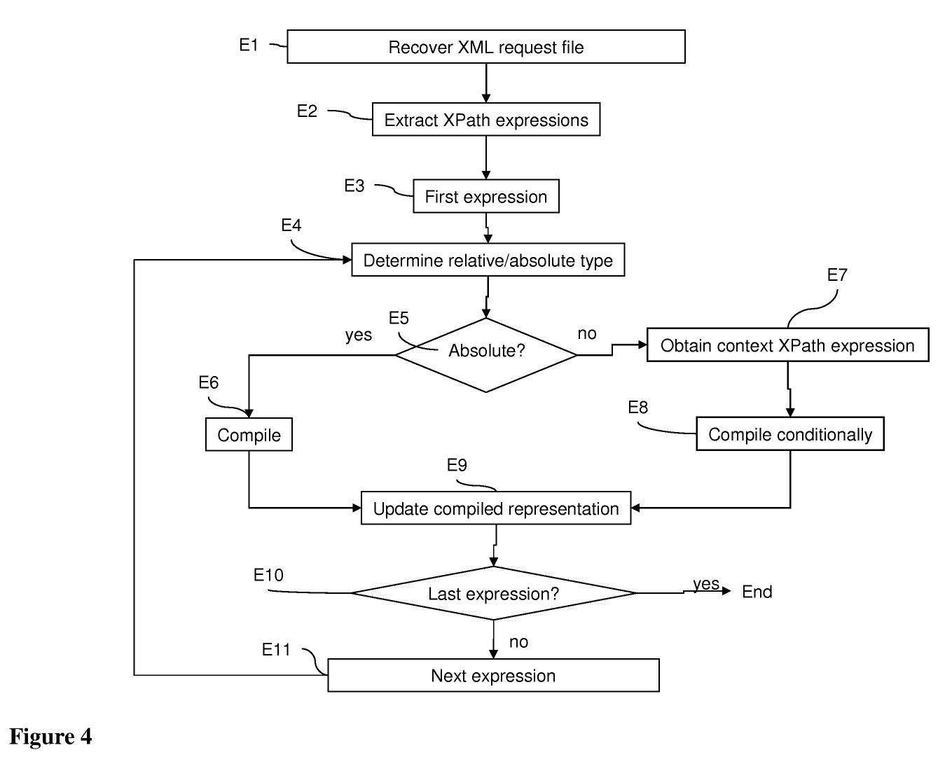

FIG. 4 represents the flow diagram of the main steps of a method of compiling a plurality of XPath expressions;

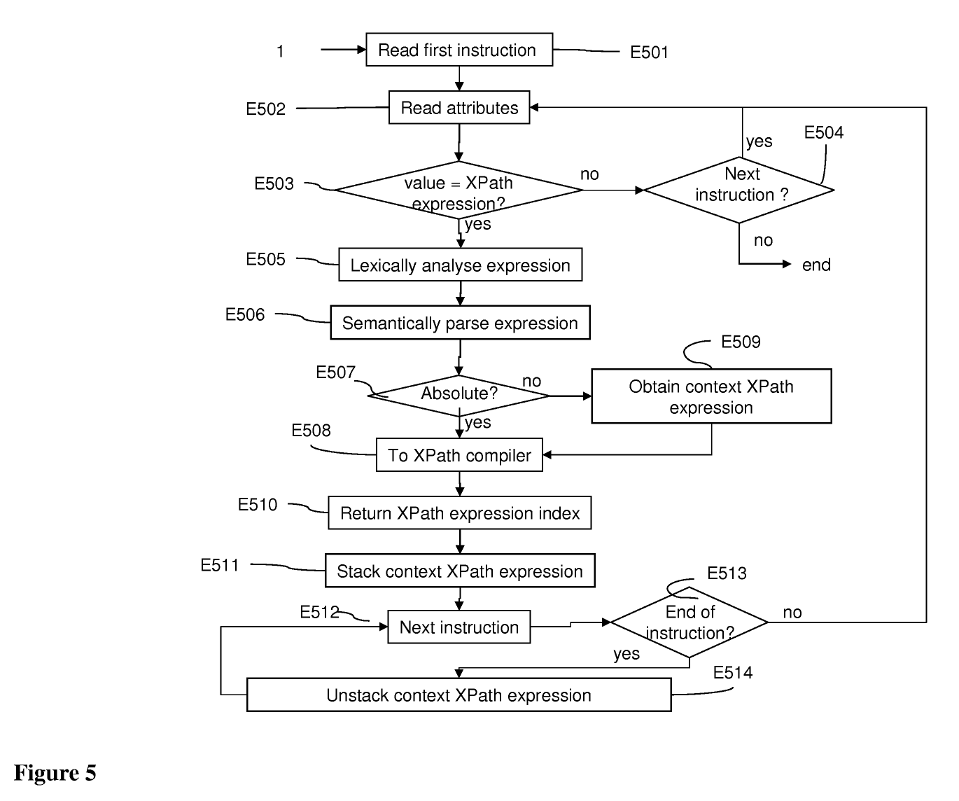

FIG. 5 details the steps relating to the analysis of the XPath expressions based on an XSL style sheet in one embodiment of the invention;

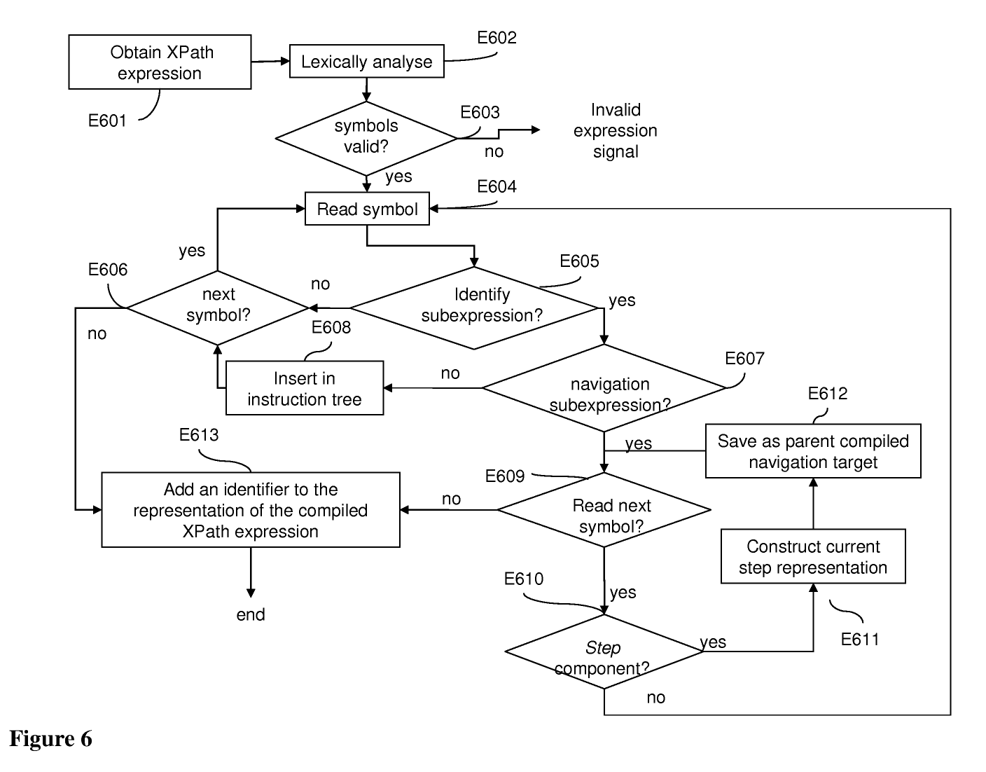

FIG. 6 details one implementation of an absolute XPath expression compilation;

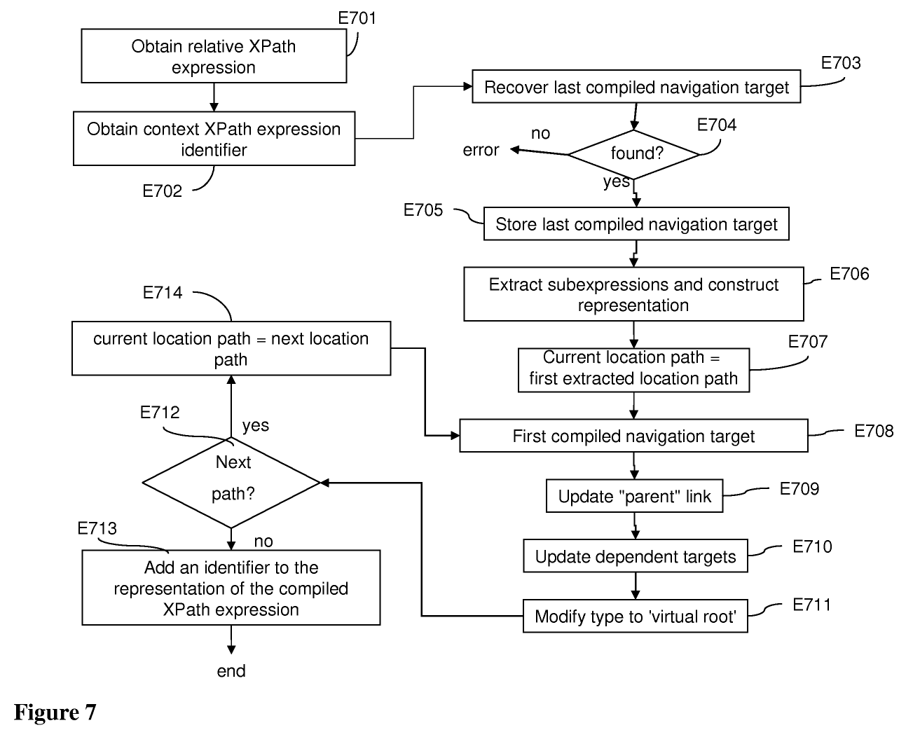

FIG. 7 details one implementation of a relative XPath expression compilation;

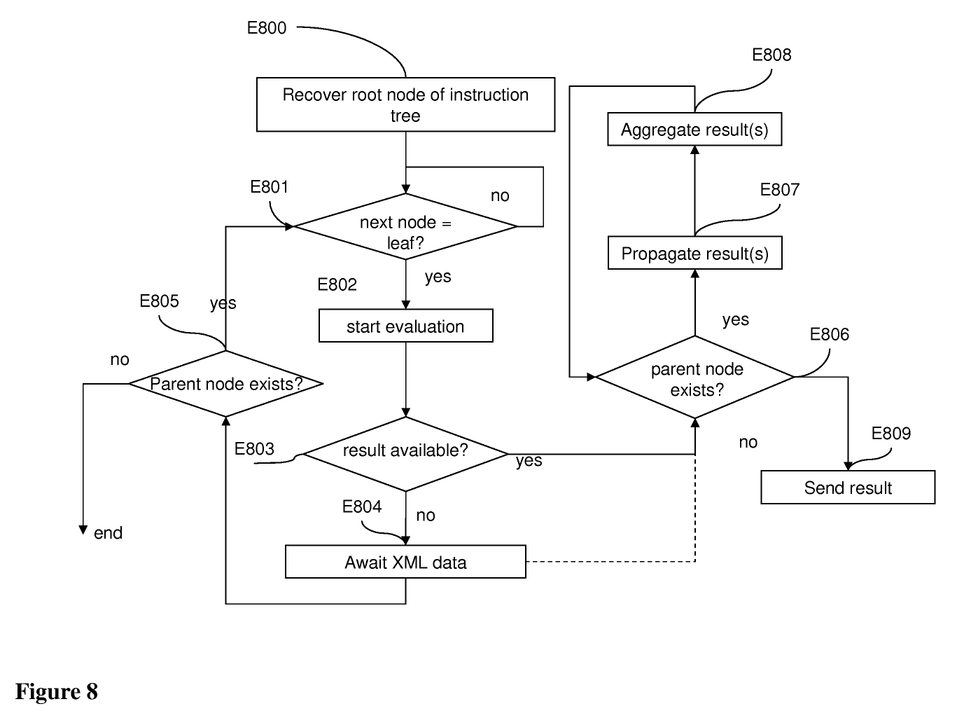

FIG. 8 diagrammatically represents the main steps of the algorithm for evaluating a plurality of XPath expressions according to the preferred embodiment of the invention;

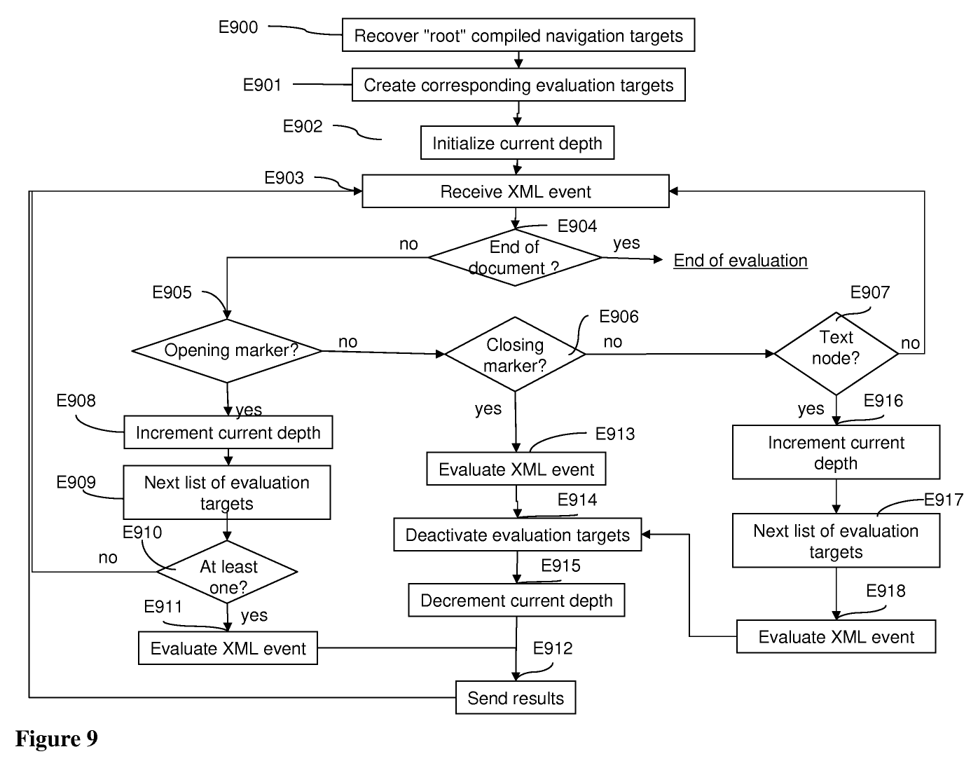

FIG. 9 represents an algorithm for evaluating expressions requiring XML data for their evaluation;

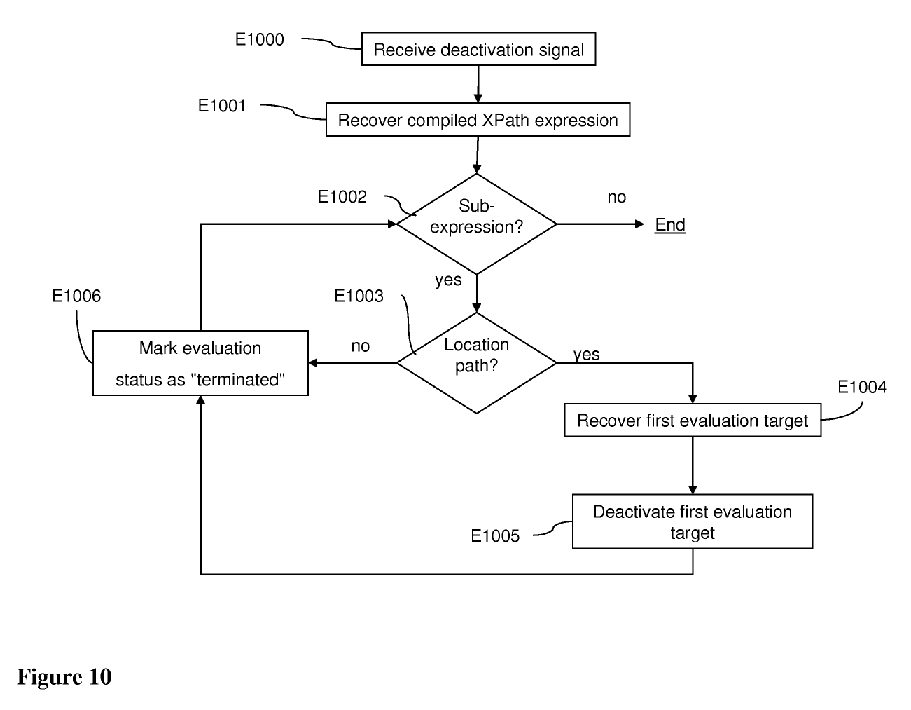

FIG. 10 represents an algorithm for deactivating compiled XPath expressions for the evaluation; and

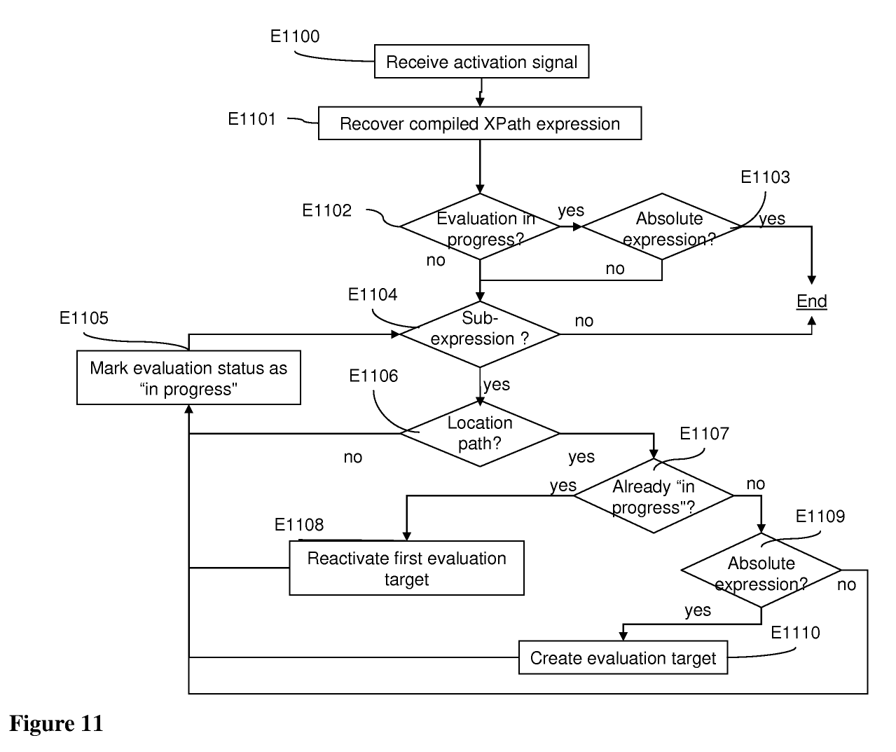

FIG. 11 represents an algorithm for reactivating compiled XPath expressions.

The description that follows describes more particularly one embodiment of the invention in its use on requests extracted from XSLT format style sheets. It should be understood that the invention applies similarly with other languages that can be used to extract a plurality of requests on XML documents. Similarly, the invention can also be applied if a user is provided with the possibility of entering a plurality of XPath expressions to be evaluated in a document, for example through an appropriate graphical interface.

FIG. 2 represents an exemplary diagram of one implementation of the invention in an application dealing with requests in XSLT language.

In this inventive implementation scenario, there is, as input, a document 1 including requests defined according to the XSLT syntax, to be applied to XML data received in an XML document 2. As output, a document 4 is supplied, the document 4 being a transformed document obtained from the document 2, possibly in XML format.

In this example, the device implementing the invention comprises a module for processing XSLT data, called XSLT processor 3, and a module for processing XPath expressions, called XPath processor 5.

The XSLT interpreter module 32 of the XSLT processor 3 extracts XPath expressions 6 contained in the document 1, and supplies them to the XPath compiler 51.

During extraction, described later with reference to FIG. 5, the lexical analyser module 33 and the semantic parser module 34 of the XSLT processor 3 are used to determine, for each XPath expression extracted, whether it is an absolute or a relative expression. For each extracted expression, the XPath compiler 51 is informed whether it is a relative or absolute expression.

The compiler uses its lexical analyser 511 and semantic parser 512 modules to obtain a compiled representation of each XPath expression, which is incorporated in a compiled representation 52.

When the XPath expression to be compiled is an absolute expression, it is, for example, compiled according to the embodiment of FIG. 6.

When the XPath expression to be compiled is a relative expression, it is compiled conditionally on an associated context XPath expression 35, supplied by the XSLT processor 3, as described below with reference to FIG. 7. A representation of the compiled relative XPath expression is incorporated in the compiled representation 52, with a link to the compiled representation of the associated context expression.

Once all the XPath expressions 6 to be processed are incorporated in the compiled representation 52, the XSLT processor 3 reads the XML document 2 and extracts therefrom XML events 7 by using the XML analyser module 31. An XML event represents an XML node, for example element start, text node, element end, comment, and so on.

The XML events 7 are received by an XPath evaluator module 53, which uses the compiled representation 52 and an evaluation target manager 54 to detect, from these received events, results 8 for one or more compiled XPath expressions 6. These results can be of different types, for example number, boolean, XML event or string. The results can be used by the XML writer module 36 of the XSLT processor 3 to construct a transformed XML document 4.

The evaluator module 53 can also contain a compiled XPath expression activation/deactivation module 531. Thus, the application is given the possibility of limiting the evaluation to a subset of XPath expressions considered relevant at a given instant. For example, in an XSLT instruction of if type, if the test is false, there is no need to activate the XPath expressions associated with the instructions nested under the if instruction.

FIG. 3 is a diagram of a processing device 1000 suitable for implementing the present invention.

The device 1000 is, for example, a microcomputer, a workstation or a lightweight portable device.

The device 1000 includes a communication bus 302 to which are connected:
a central processing unit 303, such as a microprocessor, denoted CPU;
a read-only memory 304 capable of containing computer programs in order to implement the invention, denoted ROM;
a random-access memory 306, denoted RAM, capable of containing the executable code of the method according to the invention and the registers provided to store the variables and parameters needed to implement the invention; and
a communication interface 318 linked to the communication network 50 over which digital data, for example data in XML format, is transmitted.

If appropriate, the device 1000 can also comprise the following components, included in the embodiment represented in FIG. 3:
a data storage means 312, such as a hard disk, capable of containing the programs implementing the invention and the data used or produced during the implementation of the invention;
a disk drive 314 intended for a disk 316, said disk drive being designed to read data from the disk 316 or to write data to said disk;
a screen 308 intended to display data and/or used as a graphical user interface, by means of a keyboard 310 or any other pointing means.

The device 1000 can be linked to various peripheral devices, such as, for example, a digital camera 301, linked to an input/output card (not represented).

The communication bus 302 allows for communication and interoperability between the various elements included in the device 1000 or linked to the latter. The representation of the bus is by no means limiting and, in particular, the central processing unit is capable of communicating instructions to any element of the device 1000, directly or by means of another element of the device 1000.

The disk 316 can be replaced by any information medium such as, for example, a compact disk (CD-ROM), rewriteable or not, a ZIP disk or a memory card and, in general terms, by an information storage means that can be read by a microcomputer or by a microprocessor, incorporated or not incorporated in the device, possibly removable and designed to store one or more programs, the execution of which enables the method of compiling a plurality of expressions to be evaluated in a structured document and the method of evaluating a plurality of expressions in a structured document to be implemented.

The executable code enabling the device to implement the invention can be stored either in the read-only memory 304, or on the hard disk 312, or on a removable digital medium such as, for example, a disk 316 as described previously. According to a variant, the executable code of the programs can be received by means of the telecommunication network 50, via the interface 318, in order to be stored in one of the storage means of the device 1000 before being executed, such as the hard disk 312.

The central processing unit 303 is provided to monitor and direct the execution of the instructions or of the parts of software code of the program or programs according to the invention, said instructions being stored in one of the abovementioned storage means. On power up, the program or programs stored in a non-volatile memory, for example on the hard disk 312 or in the read-only memory 304, are transferred to the random access memory 306, which then contains the executable code of the program or programs according to the invention, and registers intended to store the variables and parameters needed to implement the invention.

It should be noted that the device can also be a programmed device. This device then contains the code of the computer program or programs, for example fixed in an application-specific integrated circuit (ASIC).

FIG. 4 represents the flow diagram of the main steps of a method of compiling a plurality of XPath expressions according to a preferred implementation of the invention.

All the steps of the algorithm represented in FIG. 4 can be implemented in software form and executed by the central processing unit 303 of the device 1000.

In the step E1, the XSLT processor 3 recovers a file containing a plurality of XPath requests, for example an XSL style sheet 1.

In the next step E2, the XPath expressions 6 are extracted from this file.

The first expression in the step E3 can then be considered as the current expression. In the next step E4, the XSLT processor 3 determines whether the current expression is a relative expression or an absolute expression. The detailed implementation of this step will be explained with reference to FIG. 5.

In the step E5, a test is applied to determine whether the current expression is an absolute expression, which can therefore be evaluated from the start of the document. If such is the case, the step E5 is followed by the step E6, in which a compilation, detailed in FIG. 6, is applied.

If the current expression is a relative expression, the step E5 is followed by the step E7, in which the reference of another expression of the plurality of expressions is obtained, said other expression being the context expression of the current expression. The step E7 is followed by the step E8 for conditional compilation of the current expression relative to the context expression, which will be detailed in respect of FIG. 7.

The steps E6 and E8 are respectively followed by the step E9, for updating a compiled representation 52, the compiled representation 52 comprising the compiled representations of the XPath expressions processed. In particular, for a relative expression, a link to the associated context expression is added to the compiled representation.

The step E9 is followed by the step E10 in which a check is carried out to see if the current expression is the last of the plurality of expressions. If it is, the compilation of the plurality of XPath expressions is terminated. If the response is negative, the method goes on to the next expression in the step E11, then considered as a new current expression. The steps E4 to E10 are then iterated.

FIG. 5 details the steps relating to the analysis of the XPath expressions from an XSL style sheet in one implementation of the invention. All the steps of the algorithm represented in FIG. 5 can be implemented in software form and executed by the central processing unit 303 of the device 1000.

A document containing requests on XML data, for example an XSL style sheet 1, is supplied as input for the algorithm to the XSLT processor 3, which identifies a first instruction according to the XSLT syntax in the step E501. The XML analyser 31 and XSLT interpreter 32 modules are used to implement the step E501. Then, in the step E502, the XSLT interpreter 32 recovers the attribute or attributes associated with the identified expression.

Then, the XSLT interpreter 32 checks whether the value of one of these attributes corresponds to an XPath expression in the step E503. If it does not, the step E503 is followed by the step E504 for going on to the next instruction, if there is one (answer yes to the test of the step E504). In the case where the current processing instruction is the last instruction, that is, if the response to the test of the step E504 is negative, the processing ends.

To return to the step E503, if an XPath expression has been found, the step E503 is followed by the step E505, in which the current XPath expression is analysed by the lexical analyser 33. In this step, the series of characters of the current XPath expression is represented by a list of symbols defined by the XPath specification.

Then, in the step E506, a simple semantic parsing is used to determine whether the current XPath expression is a relative expression or an absolute expression. For this, the semantic parser 34 identifies the location path type subexpressions contained in the current expression. It then determines the first symbol contained in each of these location path type expressions. If this symbol is the ‘/’ or ‘/’ symbol, it is an absolute XPath expression. If the first symbol is an axis (AxisSpecifier), a node test (NodeTest), a location path shortcut (AbbreviatedStep) or even a function call with either a default argument corresponding to the context node, or relative location paths, it is a relative expression.

If the current expression is an absolute expression (positive response to the test E507), the XSLT processor 3 sends the current expression to the XPath processor 5 for an XPath compilation described subsequently with reference to FIG. 6.

In the case of a relative expression (negative response to the test of the step E507), the context XPath expression of the current expression is obtained in the step E509. In practice, the XSLT processor retains in RAM memory 306 information relating to the XPath expressions currently being processed (context XPath expressions structure 35), for example in data stack or context data table form. Each XPath expression has an associated representative index, which is shared with the compiled representation 52 obtained after compilation. In the step E509, the index of the XPath expression previously processed is read in memory, said XPath expression in fact being the context expression of the current XPath expression. This is due to the structure of the XSL style sheet, in which the XPath expressions are applied sequentially and in a hierarchical manner. For example, XSL instructions (‘template’, ‘apply-template’ or ‘for-each’) define a hierarchy between the XPath expression of their ‘match’ or ‘select’ attribute and the XPath expressions of the XSL instructions contained in their body. In the example of FIG. 1, the context expression of relative expressions 3 and 4 is the ‘for-each’ expression 2.

The current XPath expression and the index representative of its context expression are transmitted to the XPath processor 5 in the step E508, for a conditional compilation which will return in E510 the index of the compiled relative expression. This conditional compilation will be detailed below with reference to FIG. 7.

As explained already in light of FIG. 4, the compilation steps are followed by a step for updating the compiled representation 52, also implemented by the XPath processor 5. In this step, the current XPath expression receives an identifier, also in the form of an index. This identifier is transmitted to the XSLT processor 3 in the next step E510.

This index is added to the context expressions structure 35, by stacking when said structure is in the form of a data stack in the step E511.

Then, the next step E512 consists in advancing in the style sheet to consider the next XML node making it possible to identify a start or end of instruction. A test is then carried out to see if it is an instruction end in the step E513. If it is not, the method goes on to the step E502 already described, because it is a new instruction to be processed.

Otherwise, it is an instruction end, the step E513 is followed by the step E514, in which the XSLT interpreter 32 unstacks the index of the last context XPath expression stored in the data stack 35. This stack is followed by the step E512 for reading the next instruction in order to continue the processing.

In the preferred implementation described above, certain steps are implemented by the XSLT processor 3 and others by the XPath processor 5.

Alternatively, the XPath processor could perform the lexical analysis of the step E505 and the semantic parsing of the step E506 for the current XPath expression, to determine if it is a relative or absolute expression, then recover the identifier of the context expression of the current expression from the XSLT processor.

In an alternative implementation, the context XPath expression could be designated by a user via a graphical interface.

FIG. 6 details the step E6 of FIG. 4, in one implementation of an absolute XPath expression compilation. All the steps of the algorithm represented in FIG. 6 can be implemented in software form and executed by the central processing unit 303 of the device 1000.

The purpose of compiling an XPath expression is to prepare all the tests that must be carried out by the XPath evaluator 53 subsequently, in particular with a view to on-the-fly processing. In particular, it is necessary to identify the subexpressions of which the XPath expression is composed, and in particular the location path steps which are directly linked to the information to be retrieved in an XML document 2.

An absolute XPath expression to be compiled is received by the XPath compiler 51 in the step E601. Then, in the step E602, the lexical analyser 511 analyses the received XPath expression. A test E603 makes it possible to detect whether invalid symbols are detected. In this case, the compilation is stopped and an invalid expression signal is issued.

In the case where the symbols found are valid, the step E603 is followed by the step E604, for reading a next symbol, until an XPath subexpression is identified in the step E605. Until an XPath expression is identified, the test E605 is followed by the test E606 which checks for the existence of a next symbol. In the case of a positive response, test step E606 is followed by the step E604. In the case of a negative response, the step E606 is followed by the step E613 described below.

When a subexpression has been identified (positive response to the test E605), the method determines whether it is a navigation subexpression in the step E607. In practice, this entails checking in the step E607 that the subexpression corresponds to a location path start.

In the case of a negative response, it follows that it is a computation expression, for example a comparison expression (EqualityExpr, RelationalExpr, AdditiveExpr, MultiplicativeExpr or UnaryExpr) or a function call. In this case, a representation of this computation expression is inserted into an instruction tree in the step E608. The step E608 is followed by the step E606 already described.

In the case of a positive response to the step E607, this step is followed by the step E609 for reading the next symbol. If the next symbol exists, it makes it possible to identify an entity forming a path step from the set comprising axis (AxisSpecifier), node test (NodeTest) or predicate (Predicate) described previously in the step E610.

If the test to identify a path step component E610 fails, this step is followed by the step E604 described previously, in order to identify a new subexpression.

If a path step component is identified, the step E610 is followed by the step E611 for constructing a compiled representation of the current step in compiled navigation target form. A compiled navigation target comprises information which indicates its position in the location path (which can be ‘root’ or ‘intermediate’), information indicating its affiliation to a predicate, a link to a parent location path, links to child compiled navigation targets (if the current path step is followed by other location path steps). A compiled navigation target can also contain links to other dependent compiled navigation targets, which correspond to path steps belonging to a relative XPath expression associated with the current expression, as explained below with reference to FIG. 7.

The step E611 is followed by the step E612, in which the current compiled navigation target is saved as a node in a structure called navigation tree included in the compiled representation 52, which makes it possible to define parent-child relationships between the path steps. Thus, the current compiled navigation target can be used as a parent compiled navigation target for subsequent compiled navigation targets.

The step E612 is followed by the step E609 for reading the next symbol.

If no next symbol is found, the processing of the current absolute expression is finished. The step E609 is then followed by the step E613, in which the XPath compiler 51 associates with the current XPath expression an index enabling the current XPath expression to be identified uniquely. This index is stored in the internal representation structure 52.

Then, the compilation of the current absolute XPath expression is ended.

FIG. 7 details the step E8 of FIG. 4, in one implementation of a relative XPath expression compilation. All the steps of the algorithm represented in FIG. 7 can be implemented in software form and executed by the central processing unit 303 of the device 1000.

A relative XPath expression is compiled conditionally on a context XPath expression, as explained above with reference to FIG. 4. The context XPath expression can be a relative or absolute expression, but its evaluation must lead to a node or node set type result.

In the implementation of the invention on a request document in XSLT format, as described with reference to FIG. 2, the XPath compiler 51 receives from the XSLT processor 3 a relative XPath expression to be compiled in the step E701. Furthermore, the XPath processor also receives the identifier of the context XPath expression of the relative expression to be processed. In the preferred implementation, this identifier is an index originating from the stack of context XPath expression indices 35.

In the next step E702, the XPath compiler 51 recovers, from the compiled representation 52, the last compiled navigation target of the compiled representation of the identified context expression.

If the representation of the identified context expression does not contain a compiled navigation target, the test of the step E704 supplies a negative response and an error message is generated. In this case, the conditional compilation cannot continue. If at least one compiled navigation target is found, the response to the test E704 is positive, and this step is followed by the step E705.

In the step E705, the last compiled navigation target of the context identified context expression is stored, for example in the RAM memory 306. In practice, it is sufficient to store the memory address at which this compiled navigation target is stored.

Then, in the step E706, the relative XPath expression is processed by the lexical analyser 511 and by the semantic parser 512 to extract from it navigation type subexpressions and computation type subexpressions, as explained above with reference to FIG. 6, steps E602 to E606. The computation subexpressions extracted are inserted into the instruction tree, in a way similar to the step E608 of FIG. 6. For the location paths, their representation in compiled navigation target form is constructed, with a compiled navigation target for each path step as indicated with reference to the steps E610 and E611 of FIG. 6. The compiled navigation targets obtained are inserted into the navigation tree of the compiled representation 52, as explained above with reference to the step E612 of FIG. 6.

In the next step E707, the first location path extracted from the expression to be processed is considered as the current location path.

For this current location path, the XPath compiler 51 recovers, in the step E708, its first compiled navigation target constructed in the step E706.

In the step E709, a link indicating as parent compiled navigation target the last compiled navigation target of the context expression, which has been stored previously (E703), is added to the first compiled navigation target obtained in the step E708. Thus, a relationship link is added between the context expression and the current expression. This link is added to the compiled representation 52, and thus, it will be easy to use it subsequently for multiple evaluations without requiring additional processing.

A dependency link is also added to the representation of the last compiled navigation target of context expression, in the step E710, indicating that the first current compiled navigation target belongs to a child expression of the context expression.

Then, in the step E711, the type of the first compiled navigation target of the current expression is modified. Its type is set to the value ‘virtual root’, thus indicating that this compiled navigation target is a starting point for the evaluation of another compiled navigation target.

Then, the processing continues in the step E712, where a test is carried out to check whether there is a next location path to be processed.

If the response is positive, this step is followed by the step E714, in which the current location path is initialized with the next location path, then the steps E708 to E711 are repeated.

If there are no next location paths remaining to be processed, the step E712 is followed by the step E713, which is similar to the step E613 of FIG. 6. The XPath compiler associates with the current XPath expression an index making it possible to identify the current XPath expression uniquely. This index is stored in the compiled representation structure 52.

Thus, the compiled representation 52 comprises a complete representation of the plurality of the XPath expressions to be evaluated, in the form of a navigation tree and an instruction tree linked by functional links. Each leaf of the instruction tree corresponding to a location path will be linked to one and only one compiled navigation target of “root” or “virtual root” type.

The navigation tree comprises a set of compiled navigation targets corresponding to the navigation subexpressions included in each compiled expression, interlinked by descendancy relationships, each expression having an associated unique identifier. Each node of the navigation tree comprises a compiled navigation target.

This compiled representation 52 also includes an instruction tree representative of the computation expressions. Each node of the instruction tree comprises a structure representing the operands (links to other nodes and subexpressions) and the operator, a “container” for an evaluation result, information relating to the evaluation status which can take the values ‘being evaluated’ or ‘terminated’ and a link to a parent expression. In practice, the indices that make it possible to identify each XPath expression uniquely are stored at the first depth level of the instruction tree, each node of depth level 1 of the instruction tree corresponding to an expression to be evaluated.

This compiled representation 52 can then be used to evaluate the plurality of XPath expressions on XML data. this evaluation can be done in so-called ‘push’ mode, in which the XPath processor awaits XML data, for example sent by the XSLT processor 3 in the implementation of FIG. 2. Alternatively, the evaluation can be done in ‘pull’ mode, in which the XPath processor controls the extraction of the XML data via the XML analyser 31.

FIG. 8 diagrammatically represents the main steps of the algorithm for evaluating a plurality of XPath expressions according to the preferred implementation of the invention. All the steps of the algorithm represented in FIG. 8 can be implemented in software form and executed by the central processing unit 303 of the device 1000.

The first step E800 consists for the XPath evaluator 53 in recovering the root node of the instruction tree of the compiled representation 52.

Then, the nodes of the tree are scanned, until the next node is a leaf of the tree (test of the step E801). In the step E801, the evaluation status of the expression associated with the node concerned is set to the value ‘being evaluated’ in the instruction tree.

When a leaf of the instruction tree is reached, the XPath evaluator 53 goes on to the step E802 for starting the evaluation of the expression associated with the leaf node.

Then, in the step E803, a test is applied to determine whether a result is available without needing XML data. This occurs, for example, in the case of the comparison with a constant, or function call with a constant argument (string/number).

In the case of a positive response, the step E803 is followed by the step E806, in which a test is carried out to see if the current node of the instruction tree has a parent node. In the case of a positive response, the result for the current node is propagated to the parent node in the step E807. If this parent node has several children, the result is queued pending results from all its child nodes. Then, the step E808 for aggregating the results is carried out. Then, the processing resumes in the step E806, to carry out the propagation of the results until the root node of the instruction tree is reached. When the root node is reached, the response to the test of the step E806 is negative, and the step E806 is followed by the step E809 for sending a result. When this step is reached, this means that a result has been obtained for one of the expressions of the plurality of XPath expressions to be evaluated.

The result obtained is then sent to the XSLT processor 3 which can ask the processor for the index of the XPath expression that produced this result. Alternatively, the unique identifier of the XPath expression that produced the result can be sent simultaneously to the XSLT processor 3, at the same time as the result.

To return to the step E803, if the result is dependent on the XML data, then the leaf of the instruction tree is placed on hold pending XML data in the step E804. Furthermore, the XPath evaluator 53 inserts into the evaluation targets manager 54 an evaluation target corresponding to the ‘root’ or ‘virtual root’ compiled navigation target, as explained in detail below with reference to FIG. 9. In practice, the evaluation targets manager is stored in RAM memory 306.

Subsequently, after obtaining the result, said result can be propagated according to the mechanism explained with reference to the steps E806 to E809, which is expressed by a dotted line link in FIG. 8.

Then, in the step E805, the parent node is considered. If a parent node exists, the scanning of the instruction tree continues, by repeating the steps E801 to E804.

If no parent node has been found, therefore if the test in the step E805 supplies a negative response, the processing of FIG. 8 is ended.

FIG. 9 represents an algorithm for evaluating expressions or subexpressions placed on hold in the step E804 that require XML data for them to be resolved. All the steps of the algorithm represented in FIG. 9 can be implemented in software form and executed by the central processing unit 303 of the device 1000.

The algorithm of FIG. 9 is implemented after a full scan of the instruction tree and placed on hold in the step E804 pending all the expressions or subexpressions that require XML data for their evaluation.

In the step E900, the XPath evaluator 53 recovers a link to each ‘root’ type compiled navigation target of each location path placed on hold in the step E804 of FIG. 8, from the navigation tree of the compiled representation 52. In practice, for a location path corresponding to a leaf node of the instruction tree, the link to its first compiled navigation target is used, as represented in the navigation tree, and which corresponds to its first path step.

These compiled navigation targets are used to create the evaluation targets in the next step E901. These evaluation targets are inserted into the evaluation targets manager 54, stored in the RAM memory 306, in the form of an evaluation tree, the depth levels of the evaluation tree being obtained from the depth levels of the navigation tree.

An evaluation target is linked to the corresponding compiled navigation target, and also comprises information specific to the evaluation, for example a value indicating its activation status for evaluation, which can be “activated” or “deactivated”. Furthermore, the evaluation results can also be stored at evaluation target level, for example if a predicate remains to be evaluated for the current event.

This separation between compiled navigation targets and evaluation targets makes it possible to keep the navigation tree intact for multiple evaluations or simultaneous evaluations. For example, in the scenario of FIG. 2, as long as the XSL style sheet 1 does not change, the compiled representation 52 can be retained for all the XML documents 2 on which the evaluation of multiple XPath expressions needs to be carried out.

The step E902 is followed by the step E903, in which a variable representative of the current depth level is initialized at 0. This index is representative of the current depth level at which the evaluation targets manager is located.

In the step E903, a new XML event, for example extracted by the XML analyser 31, is received by the XPath evaluator 53.

The XPath evaluator 53 then checks as to the nature of this XML event to be processed. In the step E904, a test is applied to determine if it is a document end. In the case of a positive response, the evaluation is finished.

In the case of a negative response, the evaluation continues with the test E905, to determine if it is an opening marker.

In the case of a positive response, the XPath evaluator 53 goes on to the step E908, in which the variable indicating the current depth level is incremented by 1.

Then, in the step E909, the list of next evaluation targets is prepared. Such a list is created according to the current depth level. If there is already such a list of evaluation targets, the evaluation targets of this list are initialized. This entails checking, for each current evaluation target of said list, whether its parent evaluation target is active and whether it has been resolved in a preceding XML event. If these two conditions are satisfied, the current evaluation target is activated by the module 531. In practice, its activation status for the evaluation is set to “activated”. Otherwise, it is not activated and it will not be considered in the evaluation of the current XML event.

It is this evaluation targets activation mechanism which, in the case of an evaluation target linked to a “virtual root” type compiled navigation target, makes it possible to condition its evaluation on the evaluation of its parent evaluation target, therefore to condition its evaluation on the evaluation of the associated context XPath expression.

The step E909 is followed by the step E910, in which a check is carried out to see that the list of current evaluation targets is not empty, therefore that at least one activated evaluation target is retained in the list.

If the response to the test E910 is negative, the XPath processor 53 returns to the step E903 to process the next XML event.

In the case of a positive response, the step E909 is followed by the step E911 for evaluation of the current XML event. For each evaluation target linked to a compiled navigation target corresponding to the last step of a location path, an XPath node type result is generated in the step E912. This result is then processed in accordance with the steps E806 to E809 of FIG. 8.

Then, the method returns to the step E903 pending the reception of a new XML event to be processed.

To return to the step E905, in the case of a negative response, the current XML event is not an opening marker. The XPath processor 53 then goes on to the step E906, to check whether the current XML event corresponds to a closing marker. In the case of a positive response, it is an XML element end.

In this case, the method goes on to the next step E913, during which the evaluation targets manager 54 processes the active evaluation targets included in the list of evaluation targets corresponding to the current depth level. This step consists, for the XPath evaluator 53, in identifying, relative to the current element end, which are the unresolved location paths (for example, predicates or arguments of function calls or comparison expression operands), and which are the location paths whose result end terminates with this current element end (for example, an expression consisting only of a location path or the computation of the string representation of an element, and so on). All these cases will lead to results being generated in the step E912, described previously.

After the step E913, in the step E914, the module 54 deactivates all the evaluation targets of the list of current evaluation targets, by setting their activation status indicator for the evaluation to ‘deactivated’.

Then, the variable indicating the current depth is decremented by 1 in the step E915.

Results are generated in the step E912, discussed above.

To return to the step E906, if the response to the ‘closing marker’ test is negative, then the XPath processor 53 goes on to the step E907, in which it checks whether it is a text node. If it is not, the current XML event is disregarded, and the next step is the step E903 pending a new XML event described previously.

If the response to the test E907 is positive, the method goes on to the next step E916, in which the current depth level is incremented by 1.

Then, the list of evaluation targets at the current depth level is prepared in the step E917, in a way similar to the step E909.

If the list obtained is not empty, the evaluation is carried out in the step E918 for all the active evaluation targets of the current list. Then, the steps E914, E915 and E912 described previously are carried out.

FIG. 10 represents an algorithm for deactivating XPath expressions compiled for evaluation. All the steps of the algorithm represented in FIG. 10 can be implemented in software form and executed by the central processing unit 303 of the device 1000.

The deactivation of certain expressions of the plurality of expressions can prove useful, for example when processing several XML documents 2, some of which contain only a subpart of the data. In this case, it can be indicated in advance that it is pointless to try to evaluate certain of the XPath expressions on these documents.

The deactivation algorithm can be implemented by the module 531 of the XPath processor 5 of FIG. 2.

In a first step E1000, a deactivation signal, for one or more expressions of the plurality of expressions, is received. This could be implemented by a graphical interface in which a user can select certain XPath expressions. Alternatively, if an application uses the XPath processor 5, the latter can supply it with the identifiers of the XPath expressions of the plurality of expressions in index form, and the application can send a deactivation signal with the indices of the expressions to be deactivated.

Then, in the step E1001, the XPath evaluator 53 retrieves the XPath expression to be deactivated that corresponds to this index in the compiled representation 52. In practice, from the root of the instruction tree, the nodes of depth 1 with which there is an associated index representative of a unique identifier for an XPath expression are scanned. When the index found corresponds to the index sought, the corresponding node is selected for its deactivation.

In the next step E1002, a check is carried out to see if subexpressions of the current XPath expression still remain to be processed. If the response to this test is negative, the processing is finished.

It will be noted here that, by definition, an expression has at least one subexpression, therefore the response to this test cannot be negative on the first iteration.

If the response to the test E1002 is positive, the next step is the step E1003, in which a check is carried out to see if the current subexpression is of location path type. In the case of a negative response, its evaluation status is set to the value ‘terminated’ in the node of the instruction tree corresponding to the step E1006.

In the case of a positive response to the test E1003, therefore if it is a subexpression of location path type, the step E1003 is followed by the step E1004, in which the first evaluation target associated with this location path is recovered by the XPath evaluator 53. In practice, during the creation of evaluation targets (step E901 described previously), the XPath evaluator 53 indexes each location path being evaluated and its first evaluation target. It should be noted here that, alternatively, the creation of evaluation targets corresponding to each ‘root’ type compiled navigation target can be done from the creation of the compiled navigation targets at compilation time, for example after the step E611 of FIG. 6. Thus, the algorithm of FIG. 10 could be applied after the compilation and before the evaluation of the XPath expressions.

Then, in the step E1005, the evaluation activation status indicator obtained in the step E1004 is set to ‘deactivated’.

The step E1005 is followed by the step E1006 already described, in which the evaluation status of the current subexpression is set to “terminated” in the leaf of the instruction tree linked to the compiled navigation target associated with the current evaluation target.

FIG. 11 represents an algorithm for the reactivation of compiled XPath expressions, in particular for the reactivation of expressions that have been deactivated in accordance with the algorithm presented in FIG. 10.

All the steps of the algorithm represented in FIG. 11 can be implemented in software form and executed by the central processing unit 303 of the device 1000.

The first step E1100 consists in receiving an activation signal for one or more expressions of the plurality of expressions to be evaluated. This step is similar to the step E1000 of FIG. 10, and can be implemented in a similar way.

Then, in the step E1101, the XPath evaluator 53, and more particularly the activation/deactivation module 531, retrieves from the internal representation 52 the expression or expressions to be activated, via their unique identifier. The case of an expression to be reactivated is dealt with here, the steps having to be iterated for the processing of multiple expressions.

Then, in the step E1102, a check is carried out to see if there is an evaluation of the expressions of the plurality of expressions in progress. In practice, the XPath processor 5 checks the activation status stored in the instruction tree for the expressions to be processed.

If an evaluation is already in progress, only the relative expressions can be reactivated. Therefore, in the case of a positive response to the test in the step E102, the test E103 consists in determining whether the expression to be reactivated is an absolute expression. If it is, the processing is either finished, or it disregards the request and continues with the evaluation normally. Obviously, if there are other expressions remaining to be reactivated, the method returns to the step E1101.

If the response to one of the tests E1102 and E1103 is negative (therefore if located at the start of an evaluation or if the expression to be evaluated is relative), these steps are followed by the step E1104, in which a check is carried out to see if there is a next subexpression of the expression remaining to be reactivated. If the response is negative to this test, the processing ends.

It will be noted here that, by definition, an expression has at least one subexpression, therefore the response to this test cannot be negative on the first iteration.

If the response is positive, a check is then carried out in the step E1106 to see if the subexpression is of the location path type. In the case of a negative response, the evaluation status of the subexpression in the instruction tree of the compiled representation 52 is marked as “in progress” in the step E1105.

In the case where it is a location path, the step E1106 is followed by the step 1107 in which a check is carried out to see if an evaluation is already underway by checking the evaluation status of the current subexpression.

In the case of a positive response, the step E1107 is followed by the step E1108 in which, after recovery of the first evaluation target corresponding to this location path (as described on page 29 with reference to 1003 and 1004), the latter is reactivated. Then, the activation status of the leaf of the instruction tree corresponding to this evaluation path is set to “in progress” in the step E1105. Furthermore, the evaluation statuses of all the nodes of the instruction tree located between this leaf node and the root of the instruction tree are set to “in progress” in this same step.

In the case of a negative response to the test of the step E1107, a test is carried out see if it is an absolute expression in the step E1109. In the case of a negative response, the step E1107 is followed by the step E1105 described previously.

In the case of a positive response to the test of the step E1107, if this expression contains a location path, the evaluation targets manager 54 creates an evaluation target corresponding to the root compiled navigation target of this location path in the step E1110. This step is followed by the step E1105 described previously.

This application claims priority from French application Ser. No. 07/09007 filed on 21 Dec. 2008, which is hereby incorporated by reference in its entirety.

1. Method of compiling a plurality of expressions to be evaluated in a structured document, comprising, for each expression of the plurality of expressions to be evaluated:
determining the relative or absolute type of said expression, a relative expression being an expression, the evaluation of which depends on the evaluation of at least one other expression of the plurality of expressions,
if said expression is a relative expression, obtaining a context expression associated with said relative expression from the expressions of the plurality of expressions processed previously,
constructing a compiled representation for said expression to be evaluated, such that a compiled relative expression representation comprises a link to the compiled representation of the associated context expression.

2. Method according to claim 1, wherein the structured document comprises ‘node’ type elements, and in that the result of the evaluation of a context expression associated with a relative expression comprises at least one node of the structured document.

3. Method according to claim 1, also comprising associating a unique identifier with the compiled representation of each expression.

4. Method according to claim 1, in which an expression to be evaluated comprises at least one subexpression, the constructing a compiled expression comprises, for an expression to be evaluated:
identifying the subexpressions of said expression to be evaluated and
determining the type of the subexpression identified from the so-called navigation and computation types.

5. Method according to claim 4, in which a navigation subexpression comprises at least one location path step, the constructing a compiled expression comprising, for a navigation type subexpression, representing each location path step of said subexpression in the form of a compiled navigation target, a compiled navigation target comprising at least one information item relating to the path step type.

6. Method according to claim 1, in which the path step type is selected from the ‘root’ and ‘intermediate’ types.

7. Method according to claim 6, in which the constructing a compiled expression comprises, for a relative expression, adding an information item indicating a descendant link between the first compiled navigation target of its compiled representation and the last compiled navigation target of the compiled representation of the context expression associated with said relative expression.

8. Method according to claims 5, in which the constructing a compiled expression comprises, for a relative expression, adding an information item indicating the ‘virtual root’ type for the first compiled navigation target of the compiled representation of said relative expression.

9. Method according to claim 5, in which the compiled navigation targets are organized in a navigation tree, each compiled navigation target being associated with a node of the navigation tree.

10. Method according to claim 4, comprising, for a computation type subexpression, inserting a representation of said computation type subexpression in a node of an instruction tree.

11. Method according to claim 4, in which the instruction tree and the navigation tree are grouped together in a compiled representation, said compiled representation also comprising said identifier associated with each expression of the plurality of expressions.

12. Method according to claim 1, in which determining relative expressions comprises, for an expression to be evaluated:
lexically analysing said expression; and
semantically parsing said expression.

13. Method according to claim 3, comprising, after constructing a compiled representation of a current expression, stacking the identifier of said current expression in a storage structure for the identifiers of the expressions to be processed.

14. Method according to claim 13, in which obtaining a context expression comprises unstacking the identifier of the expression previously stored in the storage structure for the identifiers of the expressions to be processed.

15. Method according to claim 14, in which obtaining a context expression comprises:
obtaining the last identifier stored in the storage structure for the identifiers of the expressions to be processed, and
extracting the compiled representation of the compiled context expression from the identifier obtained.

16. Method of evaluating a plurality of expressions in a structured document, comprising evaluating a structured document using compiled representations of the expressions of the plurality of expressions generated by a method according to claim 1.

17. Method according to claim 16, comprising creating, for each ‘root’ type compiled navigation target, a corresponding evaluation target.

18. Method according to claim 17, in which the evaluation targets are organized in an evaluation tree according to relationship links between corresponding compiled navigation targets.

19. Method according to claim 17, in which each evaluation target comprises a value indicative of an activation status for the evaluation that can take the values ‘activated’ or ‘deactivated’.

20. Method according to claim 19, in which the evaluation step comprises:
creating a list of evaluation targets to be evaluated according to a current depth level in an evaluation tree, and
for each evaluation target in the list, setting the activation status for the evaluation to ‘activated’ according to the activation status for the evaluation of the parent evaluation target of said target.

21. Method according to claim 19, comprising deactivating evaluation of at least one expression of the plurality of expressions by, for each subexpression of said expression to be deactivated, marking an evaluation status of said subexpression as ‘terminated’.

22. Method according to claim 21, also comprising, in the case where the subexpression of the expression to be deactivated is of location path type, deactivating the activation status for the evaluation of the first evaluation target corresponding to said subexpression.

23. Method according to claim 19, comprising a reactivating evaluation of at least one expression of the plurality of expressions by, for each subexpression of said expression to be reactivated, marking an evaluation status of said subexpression as ‘in progress’.

24. Method according to claim 1, also comprising, in the case where the subexpression of the expression to be reactivated is of location path type, setting the activation status for the evaluation of the first evaluation target corresponding to said subexpression to ‘activated’.

25. Apparatus for compiling a plurality of expressions to be evaluated in a structured document, comprising, for each expression of the plurality of expressions to be evaluated:
means for determining the relative or absolute type of said expression, a relative expression being an expression, the evaluation of which depends on the evaluation of at least one other expression of the plurality of expressions,
means, able to be applied if said expression is a relative expression, for obtaining a context expression associated with said relative expression from the expressions of the plurality of expressions processed previously,
means for constructing a compiled representation for said expression to be evaluated, such that a compiled relative expression representation comprises a link to the compiled representation of the associated context expression.

26. Apparatus for evaluating a plurality of expressions in a structured document, comprising evaluation means for evaluating a plurality of expressions of a structured document using compiled representations of the expressions of the plurality of expressions generated using a method according to claim 1.

27. A computer-readable storage medium storing a computer program which, when executed by a processor in a device, causes the device to implement a method of compiling a plurality of expressions to be evaluated in a structured document, comprising, for each expression of the plurality of expressions to be evaluated:
determining the relative or absolute type of said expression, a relative expression being an expression, the evaluation of which depends on the evaluation of at least one other expression of the plurality of expressions,
if said expression is a relative expression, obtaining a context expression associated with said relative expression from the expressions of the plurality of expressions processed previously,
constructing a compiled representation for said expression to be evaluated, such that a compiled relative expression representation comprises a link to the compiled representation of the associated context expression.

28. A computer-readable storage medium storing a computer program which, when it is executed by a processor in a device, causes the device to implement a method of evaluating a plurality of expressions in a structured document, comprising evaluating a structured document using compiled representations of the expressions of the plurality of expressions generated by a method according to claim 1.

29. A computer-readable storage medium storing a compiled representation of a plurality of expressions to be evaluated in a structured document, the representation comprising a compiled relative expression, which comprises a link to a compiled representation of an associated context expression, the relative expression being an expression, the evaluation of which depends on the evaluation of the context expression.
